(19) United States
(12) Patent Application Publication
(10) Pub. No.: US 2010/0170692 A1
(43) Pub. Date: Jul. 8, 2010

(54) SPIRAL ELECTRICAL CONNECTION DEVICE AND SLIDE-TYPE ELECTRONIC DEVICE

(76) Inventors: Hsin-I Lu, Taipei City (TW); Chin-Chung Lai, Taipei City (TW); Yi-Chieh Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/647,407

(22) Filed: Dec. 25, 2009

(30) Foreign Application Priority Data
Jan. 6, 2009 (TW) 098100187

(51) Int. Cl. H01B 7/06

(52) U.S. Cl. 174/69

(57) ABSTRACT

The invention discloses a spiral electrical connection device and a slide-type electronic device therewith. The slide-type electronic device includes a base, a cover, and the spiral electrical connection device. The cover is slidably connected to the base. The spiral electrical connection device includes an electrical connection member having a first end and a second end and two connecting portions. The two connecting portions are connected to the first end and the second end of the electrical connection member, respectively. The connecting portions are electrically connected to each other via the electrical connection member, and they are connected to the cover and the base, respectively. The electrical connection member winds around a winding direction to the first end. When the cover moves away from the base, the electrical connection member extends. When the cover moves toward the base, the electrical connection member gathers around.

### BACKGROUND OF THE INVENTION

1. Field of the Invention

The invention relates to a spiral electrical connection device and a slide-type electronic device therewith and, more particularly, to a spiral electrical connection device with high extensibility and a slide-type electronic device therewith.

2. Description of the Related Art

A common slide-type phone is taken as an example, and it has two parts sliding relative to each other. Most electrical connections between the two parts are directly connected via a cable or a flat cable. The length of the cable or the flat cable is far longer than the length of the two parts after the two parts slides relative to each other to ensure that the electrical connection can be still kept when the two parts move relative to each other. Although the long cable (or flat cable) can ensure the electrical connection between the parts, it needs enough accommodating space. Thus, requirement of being light, thin, short, and small for the electronic devices is not met. Additionally, the movements of the cable or the flat cable easily interfere with other components in the same space.

### BRIEF SUMMARY OF THE INVENTION

The invention provides a spiral electrical connection device improving its extension extent via a spiral extending and gathering mechanism.

The invention further provides a slide-type electronic device with the spiral electrical connection device.

The spiral electrical connection device according to the invention includes an electrical connection member and two connecting portions. The two connecting portions are located at a first end a second end of the electrical connection member. The first end the second end of the electrical connection member are two ends of the electrical connection member, respectively. The electrical connection member is overlappingly wound around a winding direction. The connecting portions are connected to each other via the electrical connection member. Overlapping winding is not limited to an overlap that bodies of the connecting portions are connected, and it only needs that a visual angle projection of the connecting portions are overlapped when the electrical connection member is viewed from a direction perpendicular to the winding direction.

When the connecting portions move relative to each other along the winding direction, the electrical connection member extends or gathers along the winding direction. Consequently, when the spiral electrical connection device according to the invention gathers, that is, the electrical connection member overlappingly wound together, an accommodating space needed by the spiral electrical connection device is far smaller than that of the conventional electrical connection devices utilizing a bent structure to accommodate. When the spiral electrical connection device according to the invention extends, the extension extent of the spiral electrical connection device is larger than that of the conventional electrical connection devices utilizing the bent structure to extend. Additionally, when the electrical connection member is extended, a spiral overlapping design can bind each other to have an extending and gathering stability and a protection function of avoiding that components adjoining to the electrical connection member are entangled in each other.

A slide-type electronic device according to the invention includes a base, a cover, and the spiral electrical connection device. The base is slidably connected to the cover. The connecting portions are connected to the cover and the base, respectively. When the cover slides relative to the base along the winding direction, the electrical connection member extends or gathers along the winding direction. Utilizing an extending and gathering characteristic of the spiral electrical connection device, when the cover extends and gathers relative to the base, the electrical connection between the cover and the base can still keep. Furthermore, the extension extent of the spiral electrical connection device may be larger than that of conventional electrical connection devices.

Additionally, when the cover and the base need more connection points therebetween to be electrically connected, the width of the electrical connection member needs to be increased to dispose more wires. However, since the electrical connection member has an overlapping and winding structure characteristic, in contrast to a conventional technology, the increased accommodating space of the electrical connection member is much less than that of the conventional technology, and operating space may not need to be increased, which helps to design and change products.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a spiral electrical connection device in a winding state according to a first embodiment of the invention;

FIG. 2 is a schematic diagram showing the spiral electrical connection device in FIG. 1 in an extending state;

FIG. 3 is a schematic diagram showing the spiral electrical connection device in FIG. 1 in an unwinding state;

FIG. 4A is a schematic diagram showing a spiral electrical connection device in the unwinding state according to a second embodiment of the invention;

FIG. 4B is a schematic diagram showing the spiral electrical connection device in FIG. 4A in the winding state;

FIG. 5A is a schematic diagram showing a spiral electrical connection device in the unwinding state according to a third embodiment of the invention;

FIG. 5B is a schematic diagram showing the spiral electrical connection device in FIG. 5A in the winding state;

FIG. 5C is a schematic diagram showing the spiral electrical connection device in FIG. 5A in the extending state;

FIG. 6A is a schematic diagram showing a spiral electrical connection device in the unwinding state according to a fourth embodiment of the invention;

FIG. 6B is a schematic diagram showing the spiral electrical connection device in FIG. 6A in the winding state;

FIG. 6C is a schematic diagram showing the spiral electrical connection device in FIG. 6A in the extending state;

FIG. 7A is a schematic diagram showing movements of a flat plate connecting two moving parts according to a conventional technology;

FIG. 7B is a schematic diagram showing the spiral electrical connection device in FIG. 1 and the width of electrical connection member of the spiral electrical connection device is increased;

FIG. 8 is a schematic diagram showing a first embodiment of a slide-type electronic device according to the invention;

FIG. 9 is a schematic diagram showing a slide-type electronic device in FIG. 8 whose sliding cover slides to be opened; and

FIG. 10 is a schematic diagram showing a second embodiment of a slide-type electronic device whose sliding cover slides to be opened according to the invention.

### DETAILED DESCRIPTION OF THE EMBODIMENTS

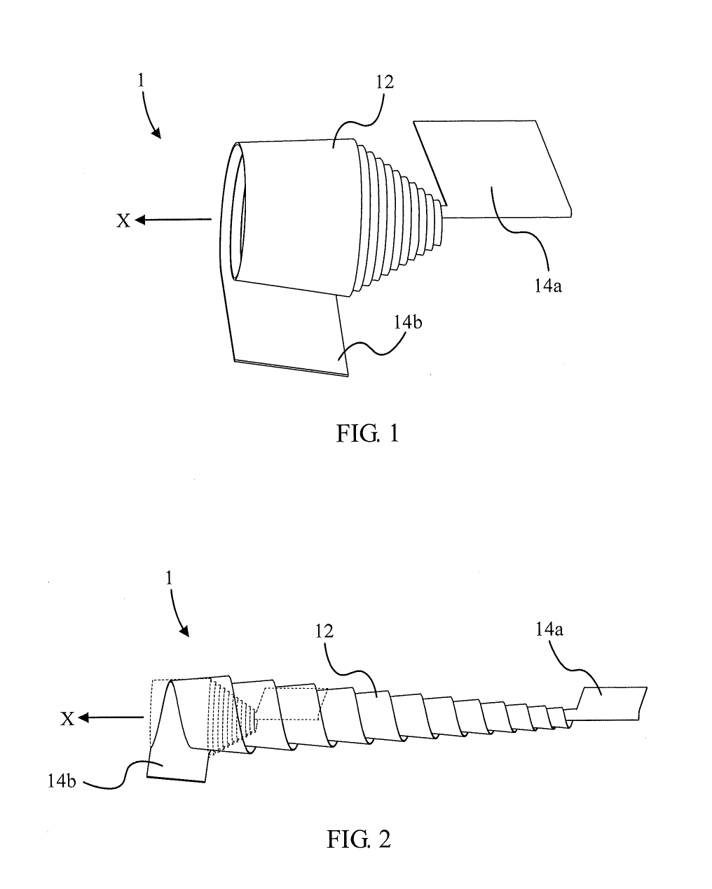

FIG. 1 is a schematic diagram showing a spiral electrical connection device 1 in a winding state according to a first embodiment of the invention. FIG. 2 is a schematic diagram showing the spiral electrical connection device 1 in FIG. 1 in an extending state. Broken lines in FIG. 2 represent the spiral electrical connection device 1 in the winding state. The spiral electrical connection device 1 includes an electrical connection member 12 and two connecting portions 14a and 14b. The two connecting portions 14a and 14b are at a first end and a second end of the electrical connection member 12, respectively. The first end and the second end of the electrical connection member 12 are two sides of the electrical connection member 12, respectively. The electrical connection member 12 may be a plate-shaped electrical connection member. The electrical connection member 12 is overlappingly wound around a winding direction X. When the connecting portions 14a and 14b move along the winding direction X, the electrical connection member 12 extends along the winding direction X.

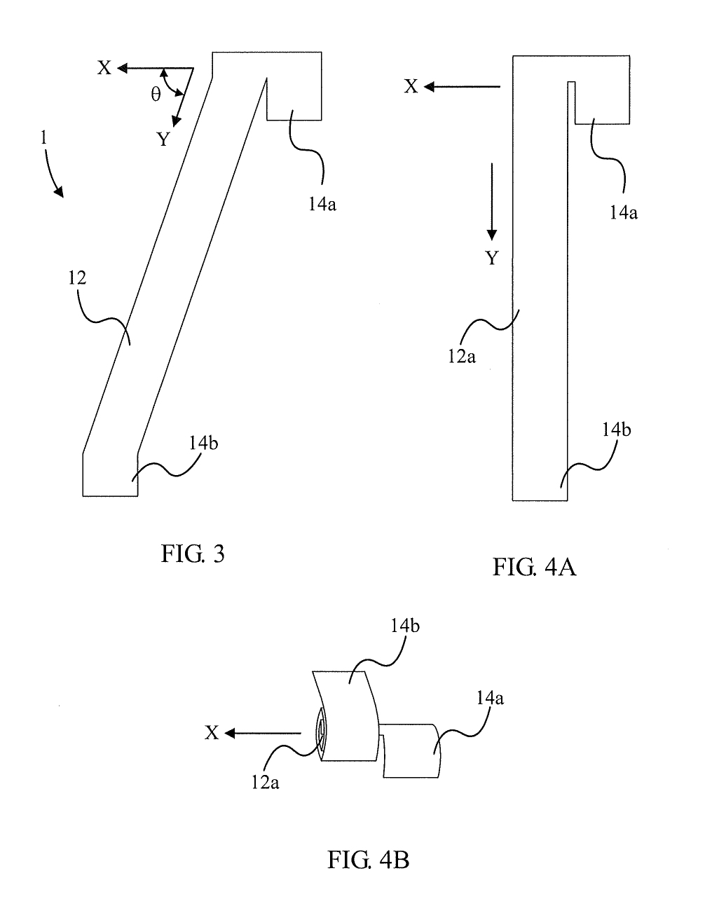

FIG. 3 is a schematic diagram showing the spiral electrical connection device 1 in FIG. 1 in an unwinding state. As shown in FIG. 1, FIG. 2 and FIG. 3, the unwound electrical connection member 12 in this embodiment may be long-strip in shape. An included angle, is formed between an extending direction Y of a body of the electrical connection member 12 and the winding direction X. The wound electrical connection member 12 includes winding portions arranged in concentric circles. Each two consecutive winding portions are series-connected in an overlapping mode as shown in FIG. 1.

FIG. 4A is a schematic diagram showing a spiral electrical connection device in the unwinding state according to a second embodiment of the invention. FIG. 4B is a schematic diagram showing the spiral electrical connection device in FIG. 4A in the winding state. Unlike the electrical connection member 12 in FIG. 3, in this embodiment, as shown in FIG. 4A, the extending direction Y of the body of the electrical connection member 12a is perpendicular to the winding direction X. Furthermore, the wound electrical connection member 12a includes the winding portions arranged in concentric circles, and the each two consecutive winding portions are series-connected in an approximately superposing mode as shown in FIG. 1.

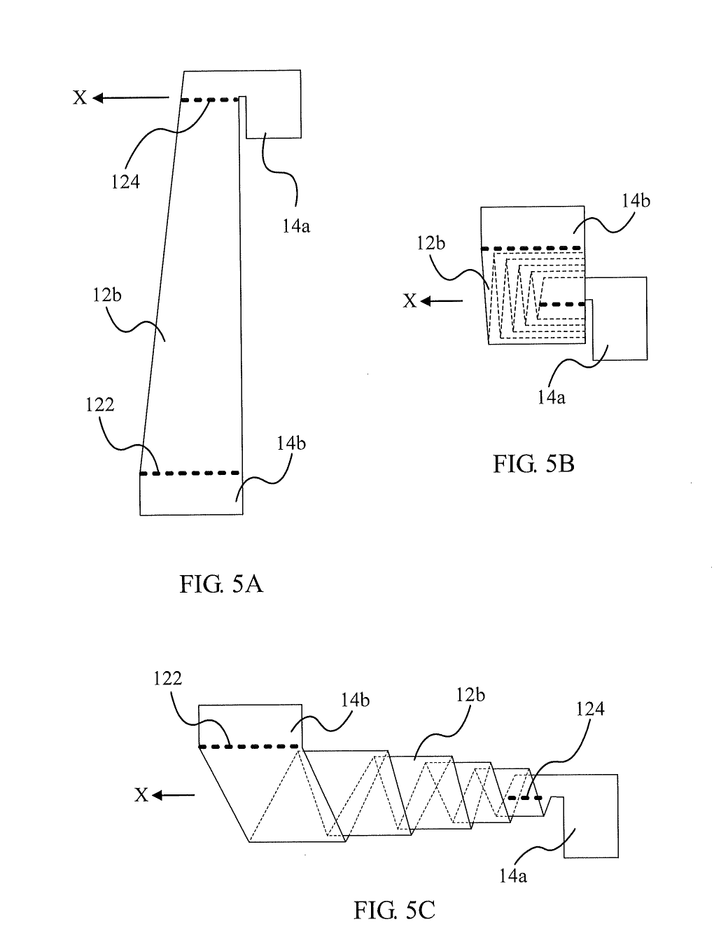

FIG. 5A is a schematic diagram showing a spiral electrical connection device in the unwinding state according to a third embodiment of the invention. FIG. 5B is a schematic diagram showing the spiral electrical connection device in FIG. 5A in the winding state. FIG. 5C is a schematic diagram showing the spiral electrical connection device in FIG. 5A in the extending state. In practical design, the electrical connection member can be designed to be trapezoid-shaped. As shown in FIG. 5A, an electrical connection member 12b is trapezoid-shaped. As shown in FIG. 5C, a long side portion 122 of the trapezoid-shaped electrical connection member 12b is wound outside, and a short side portion 124 of the electrical connection member 12b is wound inside. The long side portion 122 and the short side portion 124 are represented in the FIG. 5A to FIG. 5C via bold broken lines. Thus, as shown in FIG. 5C, when the electrical connection member 12b extends, the winding portions of the electrical connection member 12b can still keep overlapping to improve extending and gathering stability.

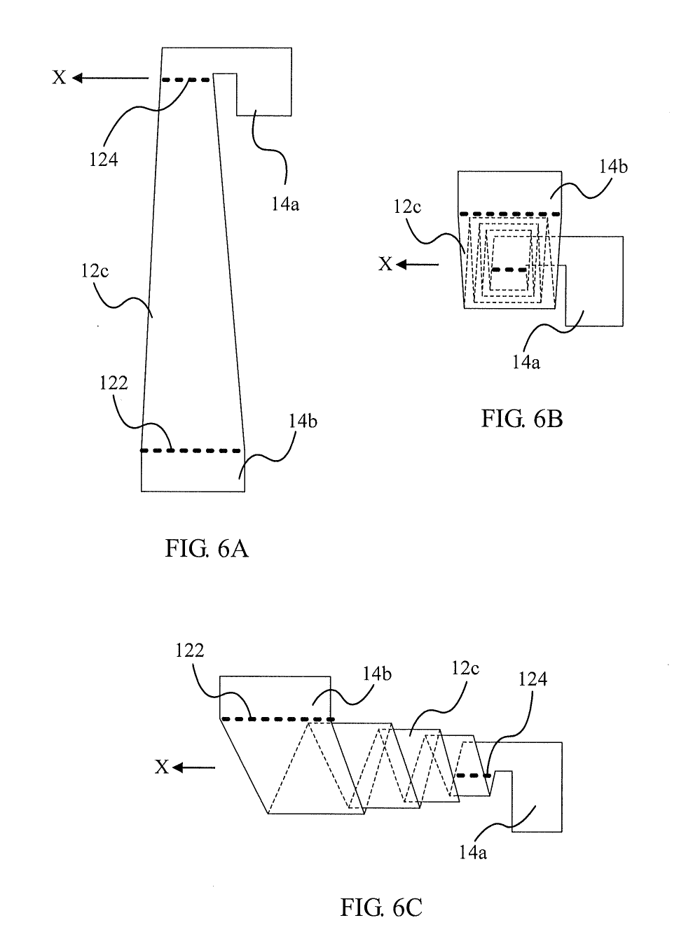

FIG. 6A is a schematic diagram showing a spiral electrical connection device in the unwinding state according to a fourth embodiment of the invention. FIG. 6B is a schematic diagram showing the spiral electrical connection device in FIG. 6A in the winding state. FIG. 6C is a schematic diagram showing the spiral electrical connection device in FIG. 6A in the extending state. The difference between a spiral electrical connection device 12c in this embodiment and the electrical connection member 12b in FIG. 5A is that the outline of the electrical connection member 12c is a symmetrical trapezoid. The long side portion 122 and the short side portion 124 are represented in the FIG. 6A to FIG. 6C via the bold broken lines. Similarly, as shown in FIG. 6C, when the electrical connection member 12c extends, the winding portions of the electrical connection member 12c can still keep overlapping with each other to improve the extending and gathering stability.

In FIG. 2, the broken lines represent the spiral electrical connection device 1 whose electrical connection member 12 is in the winding state. As shown in FIG. 2, the spiral electrical connection device 1 according to the invention utilizes a spiral extending and gathering mode to provide a longer extending and gathering distance, and the winding portions of the electrical connection member 12 can still keep overlapping with each other when extends or gathers. Thus, the spiral electrical connection device 1 has a function of protecting circuits and restricting extension and gather. Furthermore, the extending and gathering stability is improved.

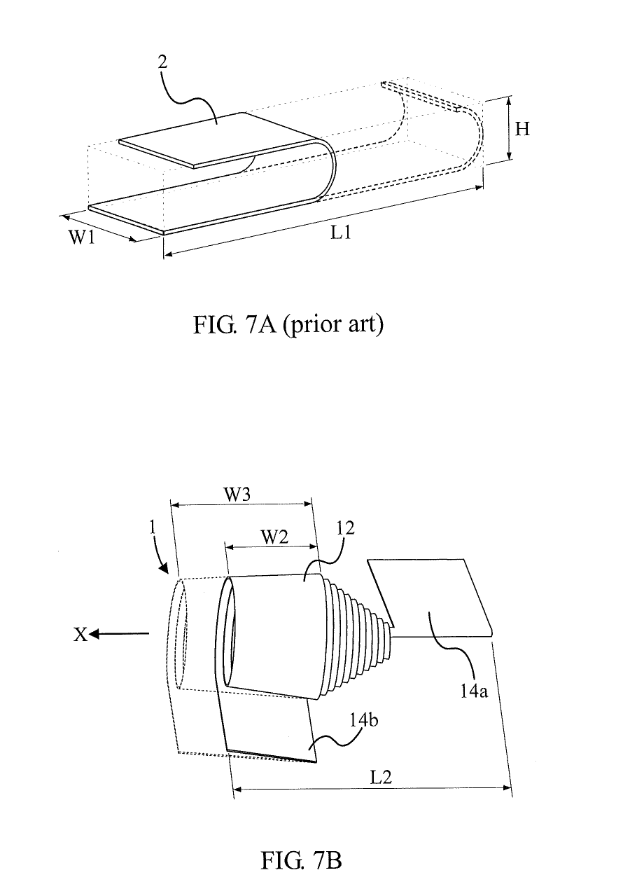

FIG. 7A is a schematic diagram showing movements of a flat plate 2 connecting two moving parts according to a conventional technology. In FIG. 7A, the broken lines represent a maximum connection distance L1 of the flat plate 2, and chain lines represent an operating space needed by the flat plate 2. In this embodiment, since the electrical connection member 12 is wound to be spiral, the operating space of the electrical connection member 12 only includes the spiral accommodating space and the space needed by the electrical connection member 12 when the electrical connection member 12 extends. In contrast, in the conventional technology, the bent flat plate 2 is usually utilized to connect the two parts sliding relative to each other. The operation space needed in this conventional connection method is approximate to the accommodating space whose volume is the maximum connection distance L1 of the flat plate 2 multiplied by a width W1 of the flat plate 2 (such as the FPC (flexible printed circuit)) and further multiplied by a structure height H. Obviously, the operation space needed by the flat plate 2 as shown in FIG. 7 is far larger than the volume of the flat plate 2 and larger than the operation space needed by the electrical connection member 12.

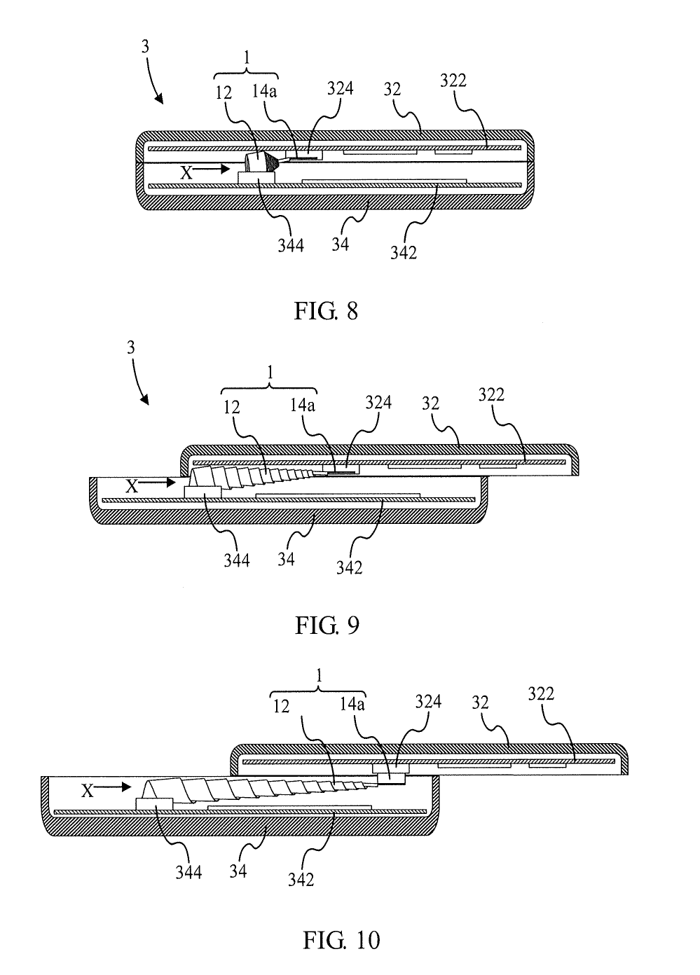

Further, the width W1 of the flat plate 2 has a considerable influence on the needed operation space. When the width W1 of the flat plate 2 in the conventional technology needs to be increased (for example, the number of wires formed on the flat plate 2 is increased), the operation space needed by the flat plate 2 is increased proportionally. FIG. 7B is a schematic diagram showing the spiral electrical connection device 1 in FIG. 1 and a width W2 of the electrical connection member 12 of the spiral electrical connection device 1 is increased. In contrast, as shown in FIG. 7B, when the width W2 of the electrical connection member 12 is increased to a width W3, only the volume of the unwound electrical connection member 12 is increased. The volume of the unwound electrical connection member 12 is in direct proportion to an overall length L2 of the shrunk electrical connection member 12. The increased volume is in direct proportion to (W3−W2)/L2 but not to (W3−W2)/W2. Furthermore, the volume of the unextended electrical connection member 12 is increased along the winding direction X (the extending direction of the electrical connection member 12). The increased volume can be accommodated in the operation space needed by the electrical connection member 12. Consequently, the structure of the spiral electrical connection device 1 according to the invention can greatly reduce an influence caused by the increase of the volume the electrical connection member 12. The influence may be that the operation space needs to be increased, which results in limiting an application range of an accommodating space configuration design of original products. The spiral electrical connection device according to the invention can be used in kinds of electrical devices composed of two parts needing to move relative to each other. FIG. 8 is a schematic diagram showing a first embodiment of a slide-type electronic device 3 with the spiral electrical connection device in the second embodiment according to the invention. The slide-type electronic device 3 may be a personal digital assistant (PDA) in the embodiment, but is also may be other electrical device having the sliding cover.

The slide-type electronic device 3 includes a cover 32, a base 34, and the spiral electrical connection device 1 in the second embodiment. The cover 32 includes a circuit board 322 and an electrical connector 324 disposed on the circuit board 322. Similarly, the base 34 includes a circuit board 342 and an electrical connector 344 disposed on the circuit board 342. The connecting portions 14a and 14b of the spiral electrical connection device 1 are connected to the electrical connector 324 and 344, respectively. The connecting portion 14b is not shown since it is inserted in the electrical connector 344. The connecting portion 14b can be found FIG. 1 and FIG. 2. Relative description of the spiral electrical connection device 1 is given in the above embodiments and descriptions thereof, and it is not described herein for a concise purpose.

The electrical connection member 12 of the spiral electrical connection device 1 according to the second embodiment may be a FPC (flexible printed circuit) or a FFC (flexible flat cable). The electrical connector 324 and 344 provide the FPC or the FFC connection interface correspondingly. Additionally, wire protection layers of the FPC or the FFC at two sides of the electrical connection member 12 can be removed to expose the wires utilized as connection points to form the connecting portions 14a and 14b. In practical design, plastic sheets may be adhered to the sides of the connecting portion 14a and 14b which non-exposed connection points to strengthen the strength of the connecting portions 14a and 14b to allow the connecting portions 14a and 14b to be easily inserted in the electrical connector 324 and 344. The connecting portions 14a and 14b of the spiral electrical connection device 1 may include electrical connectors matching with the electrical connector 324 and 344 provided by the slide-type electronic device 3 to increase the connecting strength and facilitate connection. The connecting portions 14a and 14b also may be directly soldered to the circuit board 322 and 342 to be electrically connected.

FIG. 9 is a schematic diagram showing a slide-type electronic device 3 whose sliding cover 32 slides to be opened. When the sliding cover 32 slides relative to the base 34 along the winding direction X, the electrical connection member 12 extends or gathers along the winding direction X. The winding direction X may be the same as a sliding direction along which the sliding cover 32 slides relative to the base 3. The slide-type electronic device 3 as shown in FIG. 9 can easily produce the operation distance of a conventional slide-type phone, and it also has the extending and gathering stability.

FIG. 10 is a schematic diagram showing a second embodiment of a slide-type electronic device whose sliding cover 32 slides to be opened according to the invention. The difference between the slide-type electronic device 3 in the first embodiment and that in this embodiment is the electrical connection member 12 in this embodiment is entirely accommodated in the base 34. Consequently, the electrical connection member 12 does not easily interfere with the sliding cover 32 in the extending process. As a result, the sliding cover 32 can produce a larger sliding distance. The base 34 in this embodiment only needs to have a slot to allow the connecting portion 14a to pass through to be connected to the electrical connector 324 of the sliding cover 32. In different designs, the electrical connection member also may be entirely disposed in the cover, and a slot is formed on the cover 32 to allow the connecting portion to pass through. The same effect can also be achieved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A spiral electrical connection device, comprising:
an electrical connection member having a first end and a second end; and
two connecting portions electrically connected to the first end and the second end of the electrical connection member, respectively;
wherein the electrical connection member winds around a winding direction to the first end, and when the second end of the connecting portion moves away from the first end, the electrical connection member extends; when the second end of the connecting portion moves toward the first end, the electrical connection member gathers around.

2. The spiral electrical connection device according to claim 1, wherein the electrical connection member is a flexible printed circuit (FPC) or a flexible flat cable (FFC).

3. The spiral electrical connection device according to claim 1, wherein an included angle is formed between an extending direction of the electrical connection member and the winding direction.

4. The spiral electrical connection device according to claim 1, wherein the electrical connection member is trapezoid-shaped, and having a long side portion and a short side portion, respectively, the long side portion is wound outside of the short side portion.

5. A slide-type electronic device, comprising:
a base;
a cover slidably connected to the base;
an electrical connection member having a first end and a second end; and
two connecting portions connected to the first end and the second end of the electrical connection member, respectively, and electrically connected to the cover and the base, respectively;
wherein the electrical connection member winds around a winding direction to the first end, and when the cover moves away from the base, the electrical connection member extends; when the cover moves toward the base, the electrical connection member gathers around.

6. The slide-type electronic device according to claim 5, wherein the cover or the base comprises an electrical connector electrically connected to one of the two connecting portions.

7. The slide-type electronic device according to claim 5, wherein the electrical connection member is a FPC or a FFC.

8. The slide-type electronic device according to claim 5, wherein an included angle is formed between an extending direction of the electrical connection member and the winding direction.

9. The slide-type electronic device according to claim 5, wherein the electrical connection member is trapezoid-shaped, and having a long side portion and a short side portion, respectively, the long side portion is wound outside of the short side portion.
